(19) United States
(12) Patent Application Publication
(10) Pub. No.: US 2004/0024638 A1
(43) Pub. Date: Feb. 5, 2004

(54) Computerized credit information system coupon coding

(76) Inventor: William R. Restis, South Lyon, MI (US)

Correspondence Address: The Law Office of Craig W. Barber, PO Box 16220, Golden, CO, 80402-6004, US

(21) Appl. No.: 10/209,830

(22) Filed: Jul. 31, 2002

(51) Int. Cl. G06F 17/60

(52) U.S. Cl. 705/14

(57) ABSTRACT

The present invention teaches a device allowing the use of the credit card information system, presently used to convey only credit, identification, and transaction total amount information, to convey details of the products sold and further to re-convey coupon information to the retailer. The primary server continues to serve its normal role as an arbiter or communicator between the retailer's computer system/POS terminal and those large computers used to verify transaction information, i.e. receiving and retransmitting packets of data between other computers which handle processing of the information. Database maintenance and access, transaction processing, coupon UPC matching and tranmission and other tasks are carried out by the coupon server. The additional information which needs to be sent and retransmitted is the product identifier (for example, a UPC code). Since UPC codes are also used for coupon information, this functions in both directions. Price adjustment based upon coupons is still carried out normally at the register.

The software necessary to carry out the operation at the POS station/register level may be implemented in parallel to the retailer's normal transaction applications (the software the usually handles sales, returns and other POS transactions). In one embodiment, this may be implemented at the level of COM hooks which capture and route or reroute information as needed for the operation of the invention.

### FIELD OF THE INVENTION

This invention relates generally to computerized credit card scanning and information transmission, and more specifically to the use of computerized credit information systems with coupon coding information.

### BACKGROUND OF THE INVENTION

The computerized credit information system by which computerized credit card transactions are processed begins at the POS (Point of Sale) station. The consumer or the sales clerk scans the magnetic information on a credit card by feeding the credit card's magnetic strip through a credit card scanner, a cash register, or other type of point of sale station. The scanner is normally hooked up to a printer which is able to output the sales receipt, enough credit information (for example, the last four digits of the card number) to permit identification of the card by the owner, and information identifying the sale: products, price, merchant and date.

Crucially, the scanner will also communicate with a broader computer network in order to verify the credit being used. Normally, the credit card scanner is manufactured by any one of roughly 40 makers, and used in conjunction with one of a small number of “Primary Servers”. In the US there are 5 main primary servers. These primary servers provide information to the merchant by means of the information received from the credit card scanner. The credit card scanner device (or “scanner” or “CCS”) at the POS will be configured and programmed to network with at least one (and normally one) primary server. The credit card scanner device will transmit credit card identity information (the credit card number printed on the card and present on the magnetic strip, plus any additional security digits or information present on the magnetic strip), merchant identification, and sale amount information, to the primary server it is programmed to work with. The primary server may be located at any of a number of locations, and normally “one” server actually comprises several computers in a distributive network. The primary server computer will process this information by “looking up” the identity of the card issuer and the contact information for the computer serving that card issuer and then will contact the card issuer's server with the identity of the card and merchant and the amount of the sale. The card issuer's server is that computer serving the issuing bank by checking and confirming the validity and availability of credit of the card holder in it's own file system. Again, this server may comprise several computers in a distributive network. (There are also “secondary” servers owned by the primary servers or by a financial group and offering, on a contractual basis to serve as “card issuing bank servers” on behalf of the actual card issuing banks. This is not the norm, however, for purposes of this application, the term “primary server” shall include such secondary servers and equivalent servers.) The card issuer's server responds with an acceptance or declination of the sale, or an alert to the merchant. (The card issuer's server will also debit the amount of the sale against the available credit of the card user.) The acceptance information returns to the primary server and thence to the POS station, which will allow the sale to proceed or provide a message to the customer or clerk, as programmed.

This ability to read a magnetic strip and then open up the communications channels of the computerized credit information system distinguishes magnetic strip cards from optically scanned “store” cards or “retailer membership cards” having UPC bar codes to identify the card holder. The optical scanner of the POS station is a part of the register, not the credit information system, and is unable to use the credit information system (including the primary server) for any purpose at all: the connections are simply not there. Optically scanned cards are normally used in conjunction only with discount information already stored in the retailer's own register/system. A magnetic strip is also much more complex than an optical bar code, being composed of different protocols and having a greater ability to carry information.

This entire string of digital credit information transmissions contains a remarkably small number of actual bytes of data. In practice, the card identification information may be only 20 or 30 digits and the merchant identification and amount of sale information may be almost as small. In addition, the data transmission is done in binary code, reducing the actual transmission per character/digit to as little as 6 bits. Nonetheless, the entire cycle involves the establishment of several connections and the looking up of information in several different tables in several different servers, and thus despite the small amount of information being sent, the process may take an average of 8 to 12 seconds.

The subject of this discussion now changes rather dramatically from the background of credit information systems to the background of coupon marketing. Coupon marketing, use and redemption is a more straightforward process well known to most consumers. In principle, the consumer presents a coupon at the POS and the clerk or computer adjusts the price of the product purchased based upon the coupon. Increasingly, coupons have UPC codes printed on them, allowing the coupon to be scanned like a product of negative price. The merchant is then expected to discount the item to the consumer and themselves receive a discount or redemption from the coupon originator. The coupon method has a number of advantages and flexible features inherent in the process.

First, couponing allows multi-level price adjustments and product promotions. The individual retailer may adjust prices or promote products based upon the needs of the individual retail outlet; the distributor or chain may make similar adjustments on a local or regional basis, and the manufacturer may also make adjustments on a local, regional or world-wide basis. This is in marked contrast to schemes in which the manufacturer dictates prices to retailers: such central controllers or command economics inevitably lead to inefficiencies in the sales and distribution of products. Done on a national level for an extended period of time, such command economics can lead to extreme deprivation and disruption. In addition, retailers trapped in a system in which they must sell at a dictated price will eventually succumb to free enterprise competition which is able to adjust prices rapidly and fluidly. Thus multi-level price determination by means of coupons significantly aids free enterprise competition.

Coupon marketing also allows retailers, distributors, and manufacturers to motivate consumers in the direction of a certain type of sale. For example, purely in terms of price, setting a product's price at fifty percent of the price normally charged is exactly the equivalent of a coupon offering “Buy two get two free”. However, any retailer can explain the differences in retail needs or desired consumer behavior which the two different offers will engender: coupon offers are normally time limited and thus cause faster response, a deal which involves buying four of the product will cause consumers to “stock up”, which will in turn impact later sales of the category of product, the consumer's use of the product four times may lead to an acquired taste for the product and thus brand loyalty and so on. Thus coupon marketing is considerably more flexible than mere price cutting.

There are disadvantages to the retailer in this process. Since the coupons have an actual cash value and in addition a coupon value in terms of cash discount on a product, and due to the cumulative effect of an effective coupon arriving in large quantities, accurate accounting of such coupons is an absolute necessity. When “convenient”, the retailer must count, sort, bundle and handle the coupons. In addition, the coupon originator will need to be able audit the retailer in terms of sales, coupons redeemed, and so on: due to the amounts involved, such auditing in turn creates additional overhead. In effect, the retailer must demand of the coupon originator some value equivalent to the time wasted by the retailer on the coupon campaign and accounting. This is an inefficiency in the process which in turn increases the originator's cost of coupon marketing.

Despite these disadvantages, coupon originators are eager to use the coupon process for certain types of marketing efforts. In particular, coupon marketing is an effective way to get consumers to try a product or to get consumers to try a competing product. A given percentage of such testers will become regular users of the product and will thus provide a steady revenue stream in the future.

Coupon originators (merchants, marketers, producers, manufacturers and other businesses) print up a coupon and arrange for it to be delivered to large numbers of consumers. One common method is to include a coupon in a print advertisement. The advertisement may be on the pages of a newspaper, magazine, coupon book, etc, or may be a special insert: a sheet (normally 8.5″ by 11″ (216 mm×279.4 mm) in the US but other sizes are also commonly used) which is devoted entirely to advertising the product of the coupon originator and which is inserted into a Sunday newspaper or other periodical. Coupons are also occasionally distributed by labor intensive hand-delivery processes: tucking under door-knobs, street comer distribution and so on.

There are also coupon marketing brokers which will handle the logistical details of printing, of getting coupons into a number of newspapers, of other distribution and so on. These firms and others may also analyze the coupon returns in order to determine the effectiveness of various discounts, the popularity of the underlying product and so on.

There are numerous disadvantages to all of these known systems. Firstly, many consumer do not consider it worth their time or effort to use coupons ever. Secondly, even the consumer that uses coupons will assess an offer at the time of receipt of the coupon to determine the cost/benefit of retaining, remembering and redeeming the coupon. Thirdly, if a willing consumer accidentally or circumstantially does not have the coupon present at the time of sale, they will in all probability simply elect to use their customary brand or wait until the next shopping opportunity to use the coupon.

The most efficient of coupon marketing is the insert, however, this method can be startlingly expensive: a single wide area couponing into the newspapers of a number of major metropolitan areas can be several hundred thousand dollars as of the application date. This is rather expensive.

In print couponing as part of an “in-line” or “box” advertisement is paid for at the same rate as any other advertising, thus being quite confusing.

The advent of the Internet has seen remarkably little evolution in the coupon process. One common strategy is the offering of a coupon on a website. U.S. Pat. No. 5,907,830 issued on May 25, 1999, to Engel et al, for “Electronic Coupon Distribution” is an example of coupons offered on the Internet which the consumer is expected to download and print. The consumer is expected to locate the coupon on the World Wide Web, print out the website, clip the coupon, and present it to a retailer/originator. Internet distribution can be of very low cost, however, the results are likely to be of low quality: very few consumers will actually locate and print on-line coupons, since they must pro-actively hunt for such coupons rather than having them show up on the door step.

Another problem which is almost as bad is the simple fact that Internet coupons can go astray: in one infamous case, an advantageous coupon intended for coffee drinkers in a single market was used all over the nation, resulting in franchises that were not part of the offer giving away an expensive mixed coffee beverage at two for the price of one.

This in turn points out the single greatest liability of the coupon marketing. It is mass marketing, and the consumers who will take advantage of the process are self-selected. If a consumer desires to use a coupon, they may, or they may pass it on or make its existence known to consumers who were not desired targets of the advertising. “Market Segmentation” is impossible. Market Segmentation is a desirable (for marketers) process in which each individual consumer is charged the maximum amount that the particular individual will pay, based upon the individual's need for the service or product, their ability to pay, and so on. Airline fares are the famous example of market segmentation: it is normal for the passengers on a single airliner to pay a wide variety of prices for their tickets, from very low to very high. There is an understandable tendency to regard the price paid as being inversely proportional to the functional intelligence of the consumer; this impression is false. The price variation is largely due to adroit marketing by the airlines.

There are a few methods of market segmentation available to marketers in the coupon marketing area. One recent innovation is the use of a retailer's card. This is a small card, similar to a credit card in appearance and size, which is used by the retailer to identify the consumer at the POS. Most major grocery store chains now have such a retailer member ship card, normally having UPC bar codes. The identification information on the card may be magnetic, optical (UPC code), both, or otherwise encoded. The use of such cards is beneficial for non-coupon marketing reasons: it gives the permission of the consumer to marketing firms, producers, retailers, and market analysis firms to collect detailed information on buying habits, allowing more efficient marketing. However, such cards further allow the grocery store to print out targeted coupons. If a consumer buys brand X, they may find themselves handed a coupon at the POS for a substantial discount on brand Y, or for a discount on a much larger quantity of brand X. The coupon is printed out on a special printer close to but different than the POS station printer. The system is handled entirely at the POS station/register, not at the network level nor in real time: the coupon offer is stored in the POS station/register's memory and is simply triggered by a given sale and printed out. One recent refinement is to require consumers to go to the website of the retailer to sign up for extra coupon offers, which are then downloaded to the retail POS station/register or network and offered only to the consumers who have signed up. This system at least allows consumers to know and use their offers in a single shopping trip, however it still requires the consumer to go on-line and locate coupon offers before shopping. It furthermore occurs at the level of the POS terminal/cash register.

Even this process has limitations, however, as the consumer is still required to remember, save, and redeem the coupon at a later date. In addition, since the targeted couponing is performed at the POS station there is no large scale coordination of sales effort. Most importantly, from the consumer's point of view, is the fact the coupon is awarded at the time of sale, not before, thus preventing decision making based on the availability of the coupon until at least the next trip to the retailer. Even the recent system of downloading the coupon offer to the retail point of sale station requires the user to go on-line prior to the shopping expedition.

Other inventors have tried to get entirely away from the couponing concept, using the Internet to impose centralized pricing on retailers and consumers. U.S. Pat. No. 6,249,772 B1 issued Jun. 19, 2001 to Walker et al for “SYSTEMS AND METHODS WHEREIN A BUYER PURCHASES A PRODUCT AT A FIRST PRICE AND ACQUIRES THE PRODUCT FROM A MERCHANT THAT OFFERS THE PRODUCT FOR SALE AT A SECOND PRICE” is one of the best thought out of such methods. In the method of the '772 patent, the consumer does their shopping on-line, from an on-line seller such as the manufacturer. The consumer and the manufacturer arrange a first price during the on-line transaction, and the on-line seller uses a (presumably vast) database to determine the location and inventory of the product in the consumer's area and complete the sale. The manufacturer then downloads the record of the proposed transaction to the primary server. The consumer then goes to the retailer and informs the retailer of the existence of the pre-arranged price, thus trumping whatever second price the retailer may ask for their product. Aside from the inefficiencies which centralized pricing would visit upon the overall economy, the system is disadvantageous from the viewpoint of the retailer, who in effect loses the freedom to set their own prices as appropriate for local competitive conditions. This in turn reduces the retailer to a warehousing and service function for the manufacturer.

Structural details of the '772 patent merit brief discussion. This reference teaches partial use of a credit card information system in transmission of price: from the POS terminal to the primary server discussed previously, that is the computer which normally mediates between the individual retailers/POS terminals and the computers of the credit card issuing banks. However, the '772 requires a fair amount of databasing and processing on the part of the primary server (“credit card processor”) including maintenance of a credit card number, transaction, retailer, product and price database by the primary server computer. The '772 patent further requires the primary server to filter every transaction by credit card number, verify that the retailer, transaction and product are the same as the parameters indicated on-line, and then substitute the centrally chosen first price for the retailer's second price when verifying the credit transaction with the issuing bank, then return the authorized first price in place of the retail second price. This database and processing cost may be unwelcome to the credit card processor. In addition this means that the primary server must offer the central price controller access to this database on an ongoing basis, a significant security and reliability risk that the credit card processor/primary server may be very unwilling to undertake.

From a marketing standpoint, this scheme is also undesirable for other reasons. First, this plan relies upon Internet marketing of the product, however Internet marketing's famous weakness is that it does not offer the “look, feel, ask questions” ability a retailer offers. Second, having imposed the transaction costs upon the primary server's computer system, the consumer is then free to examine the product in the store and reject it, a step which should logically be carried out prior to imposition of administrative overhead on the networks. Third, the '772 patent teaches away from coupon marketing (see for example col. 2, lines 16-37). Fourth, the '772 patent teaches away from the very concept of localized price competition. It would be preferable to have a system in which the credit card processor/primary server serves its normal function of mediation without significant databasing, a function best left to multi-level coupon marketers in any case. It would be preferable to have a system in which the primary server functions as a mediator and does not carry a horrendous centralized load of transaction/price/retailer processing; these functions are best left with the tens of millions of POS stations/registers in the millions of retailers nation-wide, or the billions world-wide.

It would be advantageous if retailers, consumers and coupon originators could entirely short circuit the process of handling of paper coupons, yet could retain the economic efficiency inherent in the coupon marketing process and multi-level price control.

It would further be advantageous if marketers, retailers and coupon originators could target coupon discounts very exactly to those consumers who would be most effected by them, would be the best customers, or would otherwise benefit from couponing. It would also be desirable to avoid offering coupons to customers that are already very loyal to or compelled to use a given product, or that simply have no history of coupon redemption.

It would also be advantageous to provide a central location at which consumers could check coupons, but without actually requiring consumers to use the Internet prior to shopping.

It would also be advantageous to provide a method of making couponing more attractive to those who are presently non-coupon-oriented consumers, for example, those in the computer industry and related high-tech industries.

It would further be advantageous to provide a method of altering coupon values and targets based upon principles of market segmentation.

It would yet further be advantageous to provide a more efficient method of coupon marketing in order to reduce overhead costs and increase the economic potential of couponing.

It would be extremely advantageous to provide a method for “automatic” coupon marketing, in which consumers can be assured that without any effort nor even any knowledge on their part or the part of the retailer, the consumer nonetheless automatically receives every coupon discount to which they are entitled.

Finally, it would be extremely advantageous if the magnetic strip card of the invention could be used in conjunction with a consumer's retail card identity, either by transmitting it or by maintaining such identity on file with a “coupon server”.

### SUMMARY OF THE INVENTION

General Summary

The present invention teaches a device and method by which consumers may automatically receive every coupon to which they are entitle, without being required to do on-line shopping, nor to clip and carry paper coupons. The invention allows multi-level price adjustments, market segmentation, reduces administration and overhead costs, and makes use of coupons more attractive to consumers, retailers and manufacturers.

The present invention teaches the a device allowing the use of a credit card information system, presently used to convey only credit, identification, and transaction total amount information to convey details of the products sold and to reconvey coupon information to the retailer. The primary server continues to serve its normal role as an arbiter or communicator between the retailer's computer system/POS terminal and those large computers used to verify transaction information, i.e. receiving and retransmitting packets of data between other computers which handle processing of the information. Whereas in known systems the primary server (which term includes secondary servers and other equivalents in the credit information system) sends credit card member ID, retailer ID and total cost information to the computers of card issuing banks, in the present invention the primary server need merely send a small additional packet of information to one additional large computer: the product, retailer and consumer identifiers to the coupon database. The credit information system, in particular the primary server, does not assume any other new duties, in particular it does not assume database responsibilities and does not assume any transaction processing responsibilities. Database maintenance and access, transaction processing, matching of purchase UPCs and card member ID with coupon UPC identification and transmission, and other tasks are still carried out by the coupon server; and the act of transaction price adjustment based upon these coupons is still performed at the cash register.

The credit card information system is already configured to convey the POS terminal and retailer at which a transaction takes place, as well as to convey large consumer identification numbers (credit card numbers). The only additional information which needs to be sent and retransmitted is the product identifier (for example, a UPC code). Since UPC codes are also used for coupon information, this functions in both directions.

The software necessary to carry out the operation at the POS station/register level may be implemented in parallel to the retailer's normal transaction applications (the software the usually handles sales, returns and other POS transactions). In one embodiment, this may be implemented at the level of COM hooks at the COM intercept layer which capture and route or reroute information as needed for the operation of the invention.

The present invention further allows use of retailer card information in associating coupons with purchased items and determining eligible discounts. The magnetic strip card of the invention may be used in conjunction with a consumer's retail card identity, either by transmitting such identity information or by maintaining such identity on file with a “coupon server”. This is something which an optical retailer's card of conventional type is unable to do, as it cannot access the credit information system.

### SUMMARY IN REFERENCE TO CLAIMS

1. It is therefore on objective, aspect, advantage and embodiment of the invention to provide a computerized coupon marketing device comprising: a card having stored thereon consumer identification information; a remote coupon server computer having stored thereon coupon information, the coupon information being associated with the consumer identification information; a point of sale station able to read information from the card; a credit information system connecting the point of sale device and the remote coupon server computer; the point of sale device transmitting to the coupon server computer via the credit information system the consumer identification information read from the card by such point of sale station; the coupon server computer transmitting to the point of sale station via the credit information system the coupon information associated with the consumer identification information.

2. It is therefore another objective, aspect, advantage and embodiment of the invention to provide a computerized coupon marketing device wherein the point of sale station is able to display the coupon information received from the coupon server computer.

3. It is therefore another objective, aspect, advantage and embodiment of the invention to provide a computerized coupon marketing device wherein the point of sale station is able to print the coupon information received from the coupon server computer.

4. It is therefore another objective, aspect, advantage and embodiment of the invention to provide a computerized coupon marketing device wherein the point of sale station is able to alter a price of items sold based upon the coupon information received from the coupon server computer.

5. It is therefore another objective, aspect, advantage and embodiment of the invention to provide a computerized coupon marketing device further comprising: a coupon information entry module allowing entry of coupon information into the remote coupon server computer.

6. It is therefore another objective, aspect, advantage and embodiment of the invention to provide a computerized coupon marketing device wherein the card is magnetically encoded.

7. It is therefore another objective, aspect, advantage and embodiment of the invention to provide a computerized coupon marketing device wherein the point of sale station is selected from the group consisting of: credit card readers, optical scanners, cash registers comprising credit card readers, cash registers comprising optical scanners and combinations thereof.

8. It is therefore another objective, aspect, advantage and embodiment of the invention to provide a computerized coupon marketing device wherein the credit information system further comprises: at least one primary server.

9. It is therefore another objective, aspect, advantage and embodiment of the invention to provide a computerized coupon marketing device wherein the credit information system further comprises: credit information transmission protocols.

10. It is therefore another objective, aspect, advantage and embodiment of the invention to provide a computerized coupon marketing device wherein the consumer identification information is in the form of Universal Product Codes.

11. It is therefore another objective, aspect, advantage and embodiment of the invention to provide a computerized coupon marketing device wherein the coupon information is in the form of Universal Product Codes.

12. It is therefore another objective, aspect, advantage and embodiment of the invention to provide a computerized coupon marketing device further comprising a second card, wherein the second card is a retailer membership card having a Universal Product Code identifying the card holder.

13. It is therefore another objective, aspect, advantage and embodiment of the invention to provide a computerized coupon marketing device wherein the coupon server further contains a retailer membership card Universal Product Code associated with the consumer identification information on the coupon card.

14. It is therefore another objective, aspect, advantage and embodiment of the invention to provide a computerized coupon marketing device, the coupon server further transmitting to the point of sale station via the credit information system the retailer membership card Universal Product Codes associated with the consumer identification information

15. It is therefore another objective, aspect, advantage and embodiment of the invention to provide a computerized coupon marketing method of coupon marketing comprising the steps of: issuing a card having stored thereon consumer identification information; providing a remote coupon server computer having stored thereon coupon information, the coupon information being associated with the consumer identification information; using a point of sale station to read information from the card; transmitting from the point of sale device to the coupon server computer via a credit information system the consumer identification information when the consumer identification information is read from the card by such point of sale station; transmitting from the coupon server computer to the point of sale station via the credit information system the coupon information associated with the consumer identification information.

16. It is therefore another objective, aspect, advantage and embodiment of the invention to provide a computerized coupon marketing method wherein the time of reading of the card is a time of sale.

17. It is therefore another objective, aspect, advantage and embodiment of the invention to provide a computerized coupon marketing method wherein the time of reading of the card is before a time of sale.

### BRIEF DESCRIPTION OF THE DRAWINGS

FIG. 1 is a block diagram of the operation of the device of the first embodiment of the present invention.

FIG. 2A is a block diagram of the operation of the register printer of the first embodiment of the present invention.

FIG. 2B is a block diagram of the operation of the bar code scanner of the first embodiment of the present invention.

FIG. 3 is a block diagram of the operation of the register of the first embodiment of the present invention.

FIG. 4 is a block diagram of the operation of the credit card scanner of the first embodiment of the present invention.

FIG. 5 is a block diagram of the operation of a primary server.

FIG. 6A is a block diagram of the operation of a coupon server according to the invention.

FIG. 6B is a block diagram of the database of the coupon server.

FIG. 7A is a block diagram of the coupon web site, in those embodiments having such a web site.

FIG. 7B is a block diagram of the database of the coupon website, in those embodiments having such a web site.

FIG. 8 is a block diagram of a PRIOR ART point of sale system at the communication level.

FIG. 9 is a block diagram of the point of sale system of the present invention, showing the use of the COM intercept layer to provide seamless integration of the present invention with a normal retail system.

FIG. 10 is a flow chart of the method of use embodiment of the present invention.

FIG. 11 is a block diagram of the operation of a PRIOR ART credit information system.

### DETAILED DESCRIPTION

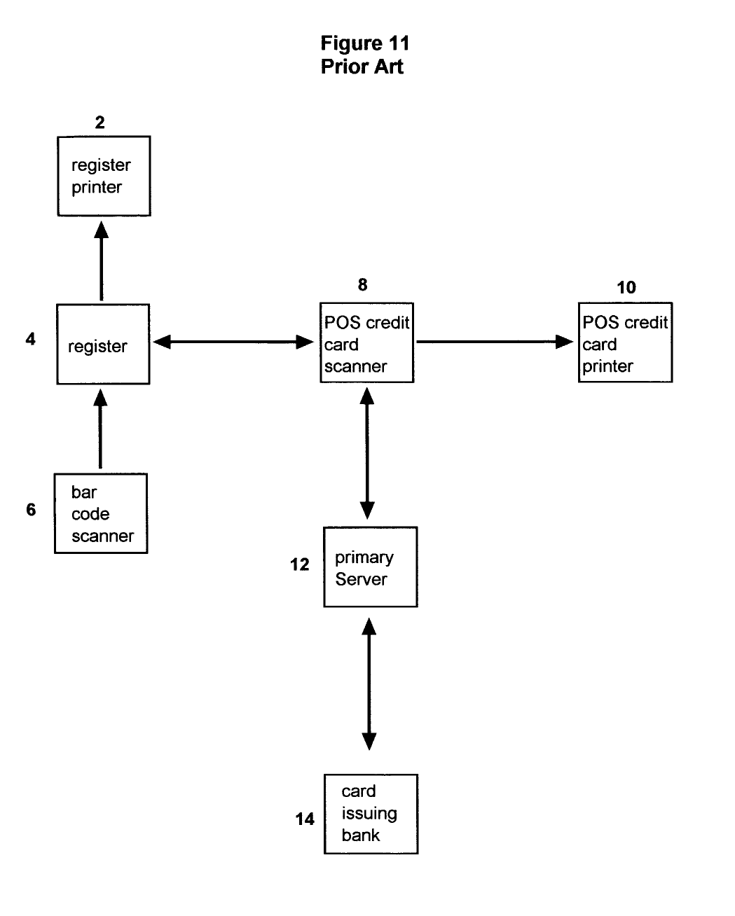

FIG. 11 is a block diagram of the operation of a PRIOR ART credit information system. In the prior art system, a consumer/sales associate (not shown) scans the UPC codes of various products and any retailer card bar code using bar code scanner 6 and then swipes a credit card using POS credit card scanner 8. Scanner 8 and register 4 cooperate to complete the sale, making use of register printer 2 and POS credit card printer 10 as needed, for example, to print the sales receipt, to print the credit acceptance receipt and so on.

The part of the system which is of interest is that POS credit card scanner 8 will communicate with primary server 12. In practice, scanner 8 is likely to be preprogrammed to automatically dial a single primary server 12, even though there are a small number of such primary servers in competition. Scanner 8 normally sends credit card number, the merchant's POS identity number and the amount of the transaction.

Primary server 12 does not have any “transaction” processing capabilities such as would alter the nature or amount of the transaction being carried out. In the contrary, primary server 12 serves as a node or nexus for communications. When POS credit card scanner 8 sends information, primary server 12 will examine the credit card number and determine the identity of the bank which issued the line of credit to the consumer. Primary server will then contact the card issuing bank 14 and re-transmit the same information received from scanner 8.

Issuing bank 14 receives the information packet, checks the credit line associated with the transmitted card number, approves or declines the extension of credit, and returns the approval or declination to the primary server, which re-transmits it to scanner 8, which in turn allows or declines the sale at register 4.

It will be appreciated that primary server 12 does very little or no databaseing: primary server 12 is essentially a relay and traffic director providing communication between scanner 8 and issuing bank 14.

As discussed previously, this will occur over the course of perhaps one half a minute or less, despite the small size of the packet being sent and resent and the wide bandwidth available. This is simply due to the time constraints necessary for communications, and due to the time necessary for issuing bank 14 to access the file of the credit card number being used.

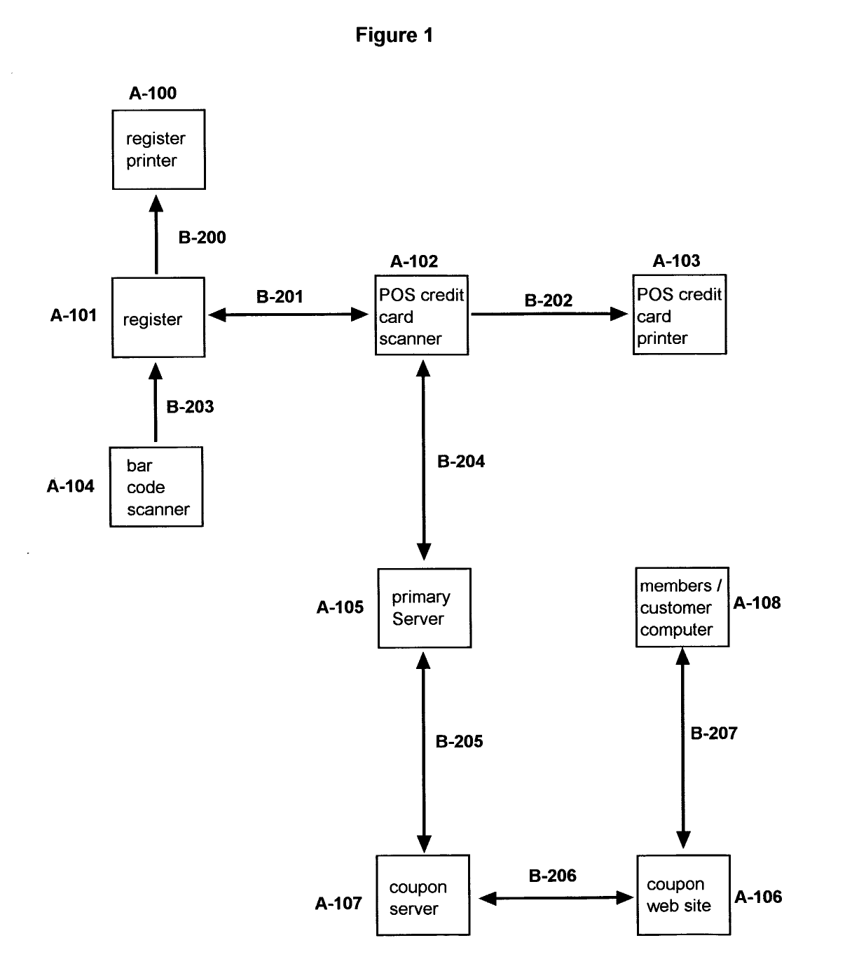

FIG. 1 is a block diagram of the operation of the device of the first embodiment of the present invention.

The invention shows that the scanner A-104, register A-101, POS terminal A-102, and printers A-100 and A-103, cooperate in the usual manner to handle the transaction, using COM links B-200 through B-203. However, additional information is also passed. In particular, the product identifications are also passed, for example, UPC codes, other bar codes, magnetic codes or other product identification codes, as may be scanned by scanner A-104, which is a bar code scanner in the presently preferred embodiment and best mode now contemplated for carrying out the invention but may be arranged to scan any of these other codes/identities in other embodiments of the invention. Thus, COM link B-203 sends UPC codes to register A-101 from scanner A-104. COM link B-201 is used to send UPC codes to credit card scanner device A-102. Other devices may also communicate UPC codes via the COM links.

Credit card scanner device A-102 also communicates UPC codes to coupon server A-107 via the computerized credit information system discussed in reference to FIG. 0. As mentioned earlier, the bandwidth of the computerized credit information system is quite wide and a delay already exists while an issuing bank (see FIG. 0, issuing bank 14) verifies the credit information. By contrast, UPC codes tend to be 20 digits or less and the typical retail transaction, even in a grocery store, is for a small number of items on the order of a dozen or two. Thus the number of extra digits to be handles is in the low hundreds. Using the binary coding standard on the computerized credit information system, this translates at 6 bits per digit into only a few thousand bits of data, an insignificant load on the wide bandwidth available on the computerized credit information system.

Along with the UPC information there will be a coupon card identity number (which may be formatted as a credit card number or as a UPC code or in another format).

Primary server A-105 need not “process” the extra information, instead primary server A-105 simply carries out its normal task of relaying information. When a packet with UPC information arrives, primary server will as usual check the credit card identity and route the credit verification request as normal (process not shown in FIG. 1 but identical to that shown in FIG. 0). It will also route the information to coupon server A-107.

Coupon server A-107 will have a database available to it containing a complete record of the coupons to which the card holder is entitled, retailer card discounts to which the card holder is entitle, associated by the identity number (UPC format, credit card format, etc) of the card. Coupon server A-107 may also maintain in alternative embodiments the retailer card identity of a given individual, so that when a transaction involving an individual is processed, coupon server A-107 may send coupon information based upon any known retailer's card discount offers. Coupon server A-107 will then return coupon information to primary server A-105, which will pass the information (again, sans processing) to the POS scanner A-102. Scanner A-102 will send the coupon information to register A-101. Register A-101 will receive this coupon information and/or retailer card identity information (if returned) in the form of UPC codes or other codes and will treat it as it would treat any other coupon entered by means of UPC scanning from scanner A-104 or manually keyed entry, etc, and will alter the sale price based upon the coupon.

In one alternative embodiment, the device and method of the invention may employed to determine coupon values during the actual manual scanning operations by code scanner A-104, so that at or shortly after the time that scanning is completed, the coupon discounts offered by coupon server A-107 will already be accounted for in the final price. In other embodiments, this information may be sent as a single packet prior to credit card scanning. In the presently preferred embodiment, this information is sent as a single packet and furthermore is combined with the credit verification request as far as primary server A-105, at which node it may be re-routed to two locations: the issuing bank and/or the coupon server.

Another feature of the present invention, one which should not be confused with online shopping such as that offered by the '772 patent, is the ability of consumers to check and upgrade a “personal coupon bank” on-line. In operation, a member uses personal computer A-108 or an equivalent terminal to communicate via COM link B-207 (which may for example be a modem, broad-band, DSL, cable, satellite dish, T1 line, optical line or other channel, or other more broadly defined channel such as the Internet and standard communications protocols such as HTML, XML, universal addressing and so on) with coupon website A-106. At coupon web site A-106, the consumer may verify all the coupons then available to them.

The closest that the present invention comes to Internet shopping is the provision for the consumer to buy “premium packages” containing extra coupons not available to the general public. This is analogous to the coupon booklets which may be bought containing coupons offering better values than those coupons available for free. Such premium packages may also be in the form of “memberships” or “executive memberships” in retail, distribution, non-profit or service organizations. Other paradigms are possible without departing the scope of the invention.

Even in the embodiments in which web site A-106 is available for use with customer computer A-108, there is no necessity for such access. The member/customer will still receive any and all coupons to which they are entitled, even if they do not ever access web site A-106. It is also important to distinguish the fact that the customer/member is NOT engaged in on-line shopping when they access web site A-106, they are at that point accessing their personal “coupon bank” to determine what coupons they are entitled to and to determine if they would like to take whatever steps are necessary in order to entitle themselves to further coupons. Finally, while some coupon offers may set a particular price for the product desired, coupon offers which merely adjust the price of a product (i.e. “50 cents off”) are also normal, thus preserving all the myriad advantages of multi-level price adjustments and of intelligent, local, retail, marketing.

The coupon servers of the invention may also be used to perform other processing tasks. For example, the offer or of a coupon or a retailer, distributor, manufacturer or other user of the device of the present invention may arrange for the coupon server to deliver a warning when certain threshold conditions are passed. Such warnings may be geared to number of coupons or amount of money discounted based upon a certain coupon, other conditions such as identity of purchaser, retailer, geographical areas, spans of times or times of day, week, month and so on: many other variables may be employed within the scope of the present invention. Coupon use and patterns of use may be established and analyzed in accord with well-known marketing principles, however, the present invention allows this to occur in real-time at the coupon server level, thus making the data instantly available on a running basis, a boon in the event of misprints of traditional coupons, fraud, fast paced competitive activities and so on.

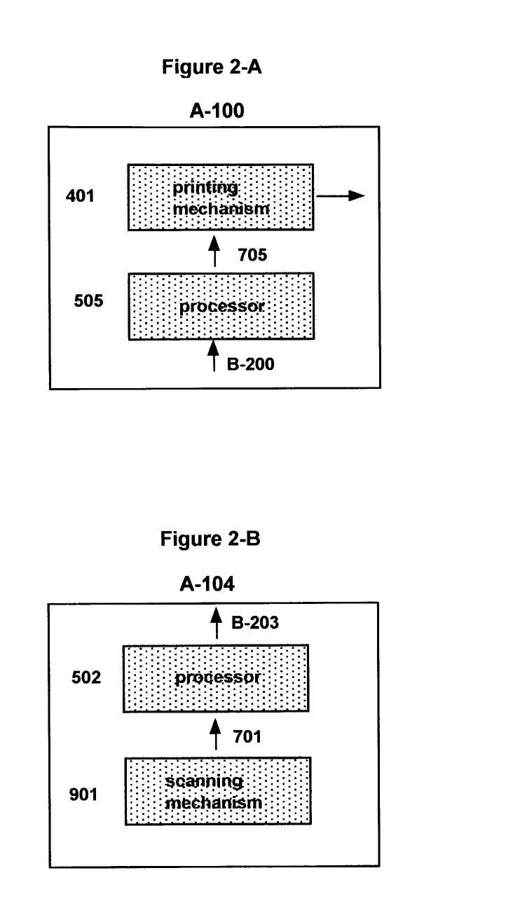

FIG. 2A is a block diagram of the operation of the register printer of the first embodiment of the present invention. In general, the printer processor 505 will receive final sale information from the register (A-101) via COM link B-200. This includes a list of items purchased and their UPC numbers, deducted coupon numbers and total. The printing mechanism 401 receives this information via internal link 705 while physically printing the final receipt.

FIG. 2B is a block diagram of the operation of the bar code scanner of the first embodiment of the present invention. Scanning mechanism 901 scans UPC, coupon UPC, and retailer membership card UPC bar codes and sends this data via internal link 701 to scanner processor 502. Processor 502 then transmits this information to the register A-101 via COM link B-203.

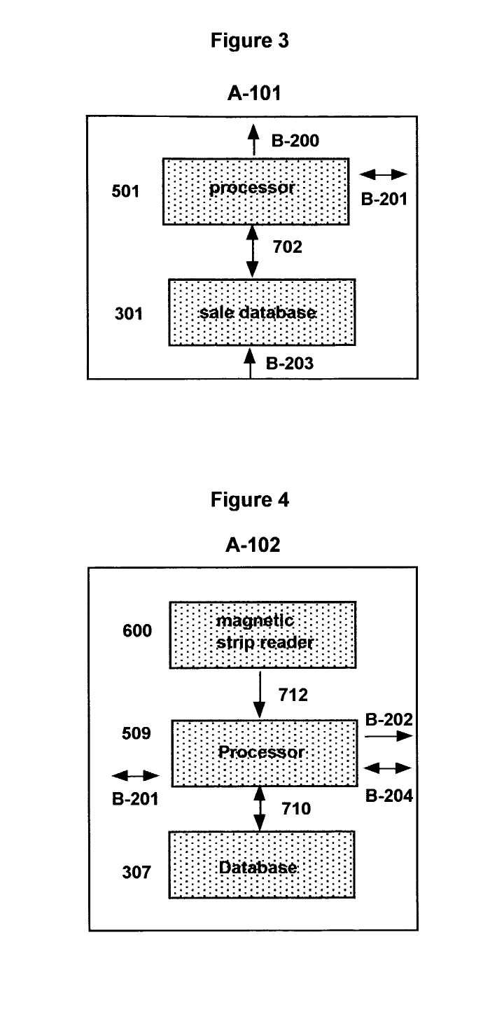

FIG. 3 is a block diagram of the operation of the register of the first embodiment of the present invention. Register A-101 may be the central unit in the retail sales transaction, or the entire POS station may be integrated, centered on credit card scanner A-102, etc. Register A-101 receives scan data sent via COM link B-203 from bar code scanner A-104. This information is stored in the sale database 301. This information is manipulated in the processor 501. Implemented software now sends specific sale UPC codes from sale database 301 via internal link 702 to processor 501, and this code further sends specific UPC sale information to the POS credit card scanner A-102 via COM link B-201. Register A-101 may also receive retailer membership card UPC bar codes and coupon UPC codes therefrom, as modern coupons are normally printed with a UPC code and scanned like they were products, resulting in a price reduction as register A-101 consults its product database for the “product” and price associated with the UPC code of the coupon. The software then further routes coupon UPC and retailer membership card UPC bar codes to processor 501 via COM link B-201 and sends specific sales information to the sales database 301 via internal link 702.

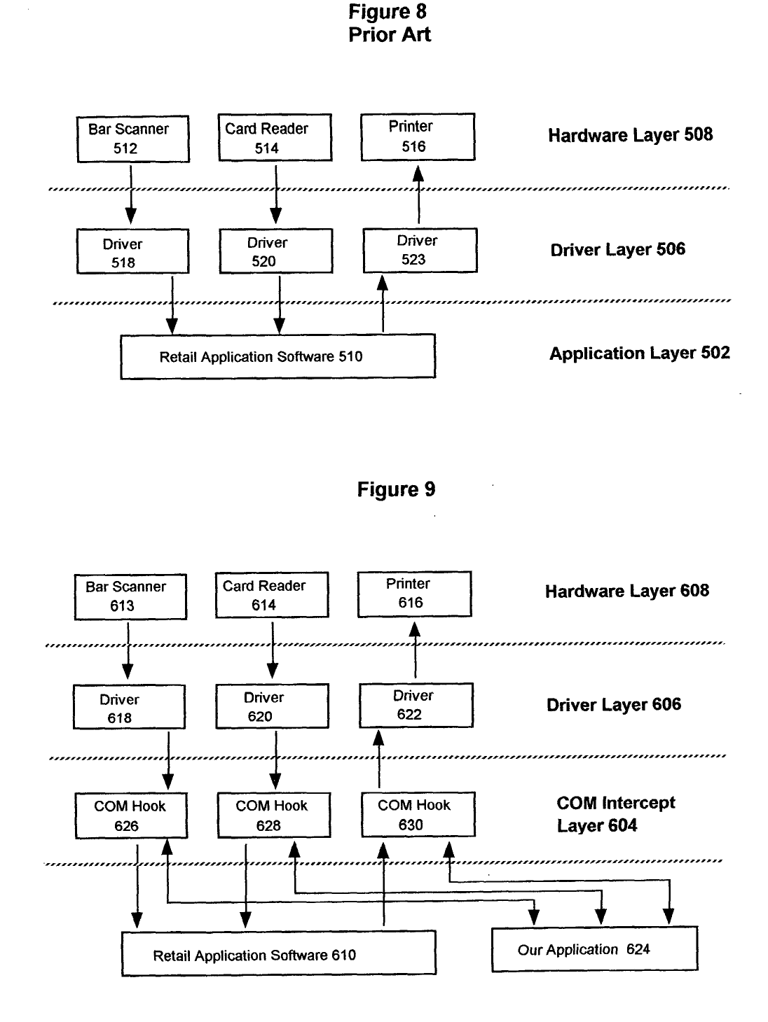

Register A-101 may use any of a number of different operating systems; although in the best mode now contemplated and presently preferred embodiment the Microsoft OPOS/OLE may be used. Modification to the OS is relatively straightforward: the retailer simply downloads a patch which allows the OS to add the functionality of the present invention to its capabilities. The mechanics of the COM hooks used to implement the presently preferred embodiment of the invention will be discussed further with respect to FIGS. 8 and 9.

FIG. 4 is a block diagram of the operation of the credit card scanner of the first embodiment of the present invention. Magnetic strip reader 600 reads information from the back of the coupon card (not shown) and sends it to processor 509 via internal link 712. The routing information on the coupon card is unique and processor 509 sends this information to the primary server A-105 via link B-204, which link may be telephone line, dedicated line, the Internet, etc. The information in database 307 contains the dial up instructions and data necessary for the selected primary server A-105, as well as retailer identification numbers. This information is sent to processor 509 via internal link 710 and to primary server A-105 via link B-204. The processor 509 transmits the information received from primary server A-105 to register A-104 via COM link B-201: thus, coupon server A-102 gets the coupon information (UPC codes and retailer membership card UPC bar codes) into the POS/cash register system.

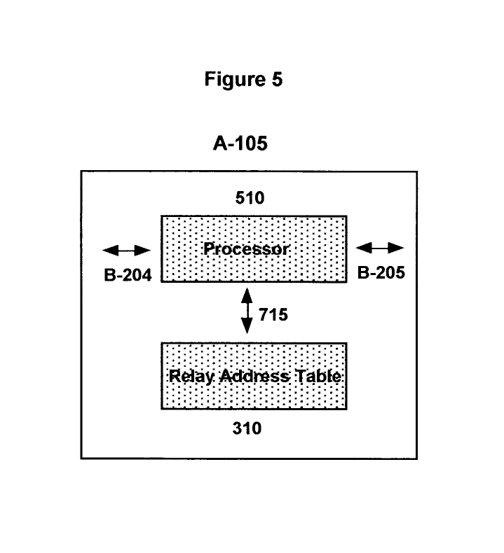

FIG. 5 is a block diagram of the operation of a primary server. Primary server A-105 has primary server processor 510 which receives, as in known systems, credit information including retailer ID and routing information. As in known systems, primary server A-105 has relay address table 310 which it consults in order to determine where and how to route credit verification requests. Table 310 is largely the extent of databasing carried out by either known credit card information system primary servers or by the primary server A-105 of the invention.

Unlike known primary servers, however, address table 310 of primary server A-105 also contains the address information needed to route data packets to coupon server A-107. In addition, primary server A-105 conveys to coupon server UPC product numbers, coupon card member identification, retailer identification and/or other routing information sent from the POS credit card scanner device A-102 via link B-204. The routing information (in the preferred embodiment, simply the card number) is used to access the address table 310 via internal link 715 and thus relay the packet or the data contained within in onwards to A-107, the coupon server. The information contained on table 310 is normally limited to an electronic address or a telephone number and whatever related communication protocol or dial-up information may be required. Whatever form link B-205 takes, the information is then sent across is to coupon server A-107. When coupon server A-107 returns UPC coupon information, retailer and retailer membership card UPC bar codes, and POS station identification and so on back to primary server A-105, primary server processor 510 then returns it to the POS station credit card scanner device A-102 via B-204.

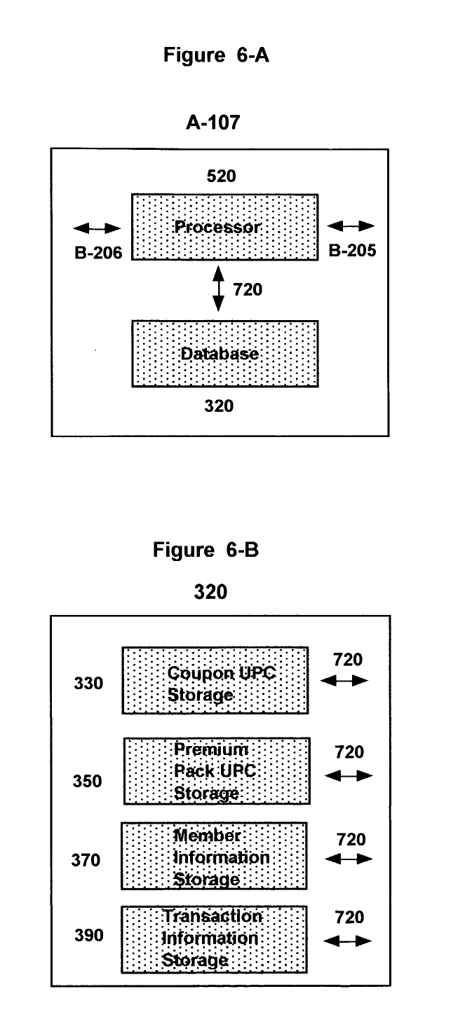

FIG. 6A is a block diagram of the operation of a coupon server according to the invention; FIG. 6B is a block diagram of the database of the coupon server. Coupon server A-107 has coupon processor 520 which receives via link B-205 the UPC numbers of purchased items, customer identification and POS credit card scanner identity information (thus enabling coupon server A-107 to identify A-102 by retailer and location). Database 320 contains coupon UPC numbers 330, premium package UPC numbers 350, and member information 370. Based upon this information processor 520 sends coupon UPC numbers/codes where they are associated with the UPC numbers of items actually purchased. Also premium information UPC numbers 350 and retailer membership card UPC bar code information via link B-205, primary server A-105 and link B-204 to POS terminal A-102 which in turn sends it via COM link B-201 to register A-101 for transaction processing. Thus the computerized credit information system functions as it normally functions, however, coupon information is sent rather than credit verification information. Note that processor 520 further sends the transaction details to the transaction information storage 390.

Link B-206 allows coupon web site A-106 to communicate with and alter the stored information/data 330, 350, 370 and 390 of database 320, and to respond thereto by the same link.

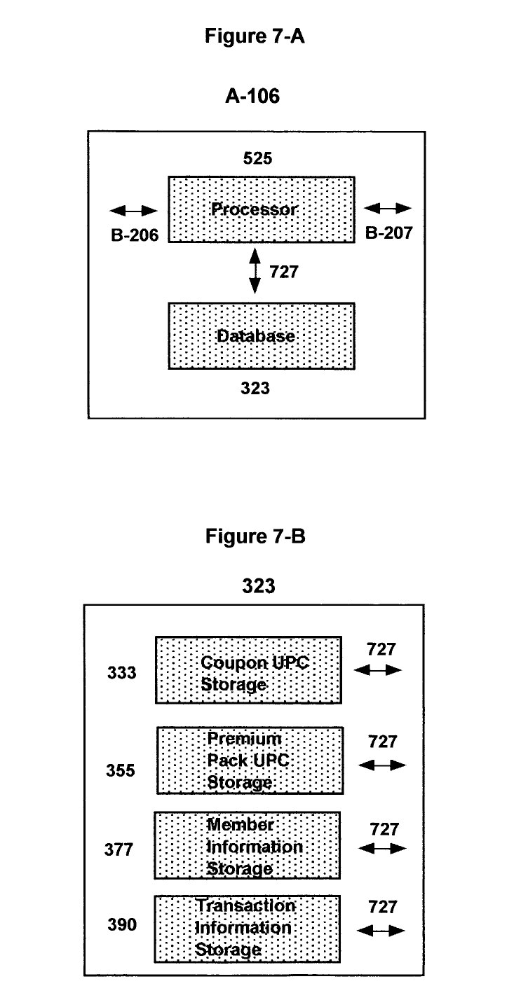

FIG. 7A is a block diagram of the coupon web site, in those embodiments having such a web site. FIG. 7B is a block diagram of the database of the coupon website, in those embodiments having such a web site. The coupon web site may be implemented in the preferred embodiment or in alternative embodiments which allow users to access their coupon bank online. Other embodiments do not allow users to access their coupon bank or allow users to access the coupon bank via human interactions, at dedicated terminals in stores, via automated telephone systems and other methods which fall within the scope of the present invention.

The web site A-106 may receive direction from a member's personal computer A-108, via link B-207 the instructions sent will cause web site A-106 to enter into or remove data from the personal coupon bank of the user (present as that data associated with that consumer's identity). This allows members to sign up, depart the service, add premium coupon packages, check and search their coupons, and so on. Such information is stored in database 323 by processor 525 by means of link 727. Coupon UPC storage 333, premium package UPC storage 355, member information storage 377 and transaction information storage 390 and more information may all be stored in database 323.

FIG. 8 is a block diagram of a PRIOR ART point of sale system at the communication level. At the application layer 502, retail application software 510 resides. Application software 510 communicates with bar scanner 512, card scanner 514, printer 516 and other devices or peripherals on the hardware layer 508, which are controlled by means of drivers 518, 520 and 522 on driver layer 506. These drivers normally interface with the actual COM links which in turn physically connect the various devices.

Physically and in terms of protocol, a wide variety of connections are actually used, many of them ubiquitous in telecommunication settings. RJ-11, RJ-45, RS-232 and RS-232-C, parallel ports, USB ports, IEEE-1394 ports and others are all employed: quite often a number of different ports are employed on a single device. While data is normally sent binary, a number of communications protocols may also be used within the scope of the present invention.

FIG. 9 is a block diagram of the point of sale system of one embodiment of the present invention, showing the use of COM intercept layer 604 to provide seamless integration of the present invention with a normal retail system. In practice, application layer 602 and retail application software 610 function normally, as do bar scanner 612, card reader 614 and printer 616 on the hardware layer 608 and drivers 618, 620 and 622 oh driver layer 606.

However, COM intercept layer 604 has COM hooks 626, 628 and 630 which intercept communications of the type necessary for practice of the present invention (such as transmission of UPC codes, etc) and reroute them to the application of this embodiment of the device.

The advantages of this method are that it provides seamless and immediate integration without the need for extensive re-writes of the existing code of retail application software, drivers and so on. In other embodiments, the entire software package of the POS station/register/peripherals may be written out ab initio to include the functionality of the present invention, thus obviating the need for the COM intercept embodiment, albeit at greater cost. These other embodiments fall within the scope of the present invention.

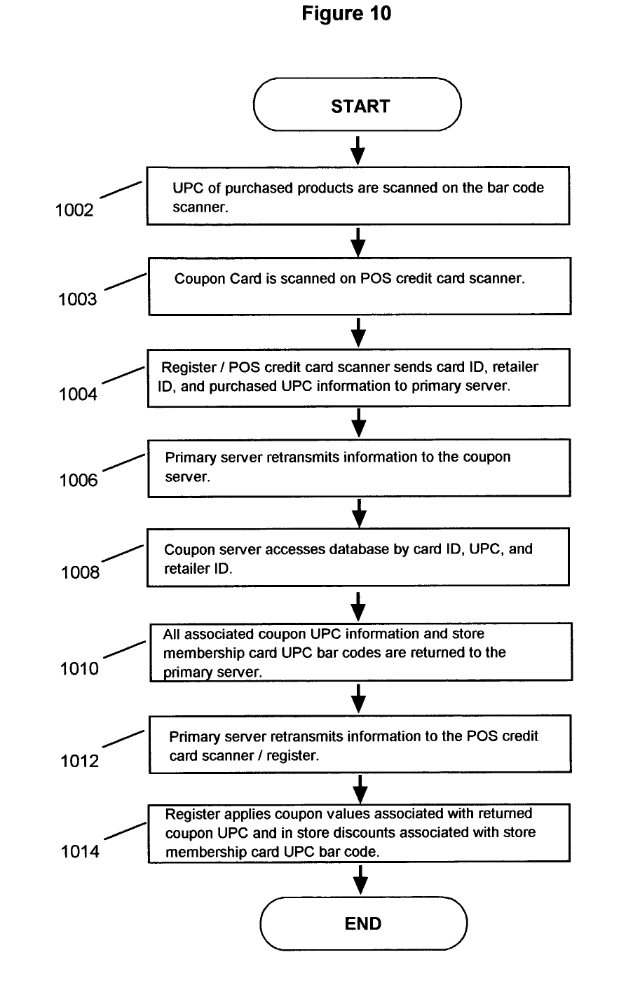

FIG. 10 is a flow chart of the method of use embodiment of the present invention. As will be appreciated, this may simply be the description of the method of use of one embodiment of the device above, and while details of each step, structure, detail of implementation and alternative embodiment are not repeated herein for the sake of brevity, such details may be found above or determined therefrom and applied to the following method embodiment without undue experimentation.

At step 1002, the retailer membership card ID (a UPC bar code) if any, and the UPC numbers of purchased products are scanned. At step 1003, the coupon card is scanned on the POS credit card scanner. At step 1004, the POS/register sends the scanned information and the POS/register ID to the primary server. (The POS/register ID serves to identify the retailer). At step 1006, the primary server retransmits the information to the coupon server, and at step 1008, the coupon server accesses its own databases, searching for coupons associated with the retailer ID, the card ID and/or the UPC codes of purchased products. All coupon UPC codes which match the criteria are then returned to the primary server at step 1010 and at step 1012, the primary server serves its mediation/traffic direction function by retransmitting the information (coupon UPC codes) back to the originating POS/register. Finally, at step 1014, these coupons are applied to the sale by the POS/station register automatically, without intervention by the consumer or sales associate and the transaction is completed on the basis of the coupons. In embodiments, one UPC code of one product may be transmitted by this method, or a plurality of UPC codes, any number up to the entire purchase inventory may be transmitted in one packet, or all the UPC codes and the credit verification request may all be sent together.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A computerized coupon marketing device; the device comprising:
a) a card having stored thereon consumer identification information;
b) a remote coupon server computer having stored thereon coupon information, the coupon information being associated with the consumer identification information;
c) a point of sale station able to read information from the card;
d) a credit information system connecting the point of sale device and the remote coupon server computer;
e) the point of sale device transmitting to the coupon server computer via the credit information system the consumer identification information read from the card by such point of sale station;
f) the coupon server computer transmitting to the point of sale station via the credit information system the coupon information associated with the consumer identification information.

2. The device of claim 1, wherein the point of sale station is able to display the coupon information received from the coupon server computer.

3. The device of claim 1, wherein the point of sale station is able to print the coupon information received from the coupon server computer.

4. The device of claim 1, wherein the point of sale station is able to alter a price of items sold based upon the coupon information received from the coupon server computer.

5. The device of claim 1, further comprising:
g) a coupon information entry module allowing entry of coupon information into the remote coupon server computer.

6. The device of claim 1, wherein the card is magnetically encoded.

7. The device of claim 1, wherein the point of sale station is selected from the group consisting of: credit card readers, optical scanners, cash registers, cash registers comprising credit card readers, cash registers comprising optical scanners and combinations thereof.

8. The device of claim 1, wherein the credit information system further comprises:
h) at least one primary server.

9. The device of claim 1, wherein the credit information system further comprises:
i) credit information transmission protocols.

10. The device of claim 1, wherein the consumer identification information is in the form of a Universal Product Code.

11. The device of claim 1, wherein the coupon information is in the form of Universal Product Codes.

12. The device of claim 1, further comprising a second card, wherein the second card is a retailer membership card having a Universal Product Code identifying the card holder.

13. The device of claim 1, wherein the coupon server further contains a retailer membership card Universal Product Code associated with the consumer identification information on the coupon card.

14. The device of claim 13, the coupon server further transmitting to the point of sale station via the credit information system the retailer membership card Universal Product Code associated with the consumer identification information

15. A computerized coupon marketing method of coupon marketing comprising the steps of:
a) issuing a card having stored thereon consumer identification information;
b) providing a remote coupon server computer having stored thereon coupon information, the coupon information being associated with the consumer identification information;
c) using a point of sale station to read information from the card;
d) transmitting from the point of sale device to the coupon server computer via a credit information system the consumer identification information when the consumer identification information is read from the card by such point of sale station;
e) transmitting from the coupon server computer to the point of sale station via the credit information system the coupon information associated with the consumer identification information.

16. The method of claim 15, wherein the time of reading of the card is a time of sale.

17. The method of claim 15, wherein the time of reading of the card is before a time of sale.
